(19) United States
(12) Patent Application Publication
(10) Pub. No.: US 2009/0169938 A1
(43) Pub. Date: Jul. 2, 2009

(54) FUEL CELL APPARATUS

(75) Inventor: Shinichi TAKAHASHI, Kanagawa (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 12/397,835

(22) Filed: Mar. 4, 2009

Related U.S. Application Data
(63) Continuation-in-part of application No. 12/071,081, filed on Feb. 15, 2008.
Application No. 12/071,081 is a continuation of application No. 10/811,899, filed on Mar. 30, 2004.

(51) Int. Cl. H01M 8/04; H01M 2/02

(52) U.S. Cl. 429/24; 429/34; 429/22

(57) ABSTRACT

A fuel cell is comprised of an electrode structure including a cathode, an anode and an electrolyte put between the cathode and the anode; a fuel gas passage configured to conduct fuel to the anode; an air passage configured to conduct air to the cathode; a separator configured to supply the fuel to the fuel gas passage; and a water channel configured to allow flow of water and permit the water to pass into the separator, the water channel including a hollow structure having an inner surface and polymers respectively having polymer chains, one end of the polymer chains being connected to the inner surface and capable of forming an entanglement bindable to water molecules.

### CROSS-REFERENCE TO RELATED APPLICATIONS

This application claims the benefit of domestic priorities from and is a continuation-in-part of U.S. patent application Ser. No. 10/811,899 (filed Mar. 30, 2004) and Ser. No. 12/071,081 (filed Feb. 15, 2008); the entire contents of which are incorporated herein by reference.

### BACKGROUND OF THE INVENTION

1. Field of the Invention

The present invention generally relates to fuel cells, and more particularly to improvements in the performance of polymer fuel cells having a water channel.

2. Description of the Related Art

In a fuel cell that contains a water channel, the water in the water channel freezes at temperatures of 0° C. or below. Consequently, if the fuel cell is in an environment of 0° C. or below, the water in a frozen state may block the water channel, thereby preventing conveyance of water, and the fuel and air passages may also be clogged due to frozen water. This issue could be more serious if the water channel has a hollow structure at least in part, as the interior of the hollow structure provides room for the water to form a lump of ice and is thereby clogged. If a fuel cell is started up in a frozen state, it may take a long time to reach the rated output, since it is necessary to melt the accumulated ice. Alternatively, the interior of the fuel cell stack, which includes the polymer membrane, may be damaged, thereby worsening cell performance.

One method of solving this problem is to discharge the water from the channel outside of the cell when the fuel cell is shut down. The water can be discharged by gravity, or by using a pump. For instance, in Japanese Patent Application Unexamined Publication H11-273704, a fuel cell is equipped with a means for drainage. After cell operation is completed, the means of drainage comes into effect, and the water accumulated in the fixed polymer fuel cell, tank, supply means, and discharge means is discharged to the outside. Thus, even when the fuel cell equipment is operated outside in a cold climate and is subsequently shut down, there is no frozen water inside the fuel cell, and consequently the water channel is not blocked due to freezing when the fuel cell is restarted.

If the water channel has a humidifying or cooling function, it cannot perform these functions when the fuel cell is started up, since there is no water in the channel after discharge. Therefore, when the fuel cell is restarted, it is necessary to re-supply the water channel with water, because recirculated water alone is not enough. In addition, discharging a large quantity of water from the fuel cell has other disadvantages. For instance, given a fuel cell for automotive use, there is the risk of causing the road to ice over if a large quantity of water is discharged to the outside environment at sub-zero temperatures. For this reason, others have employed a reservoir tank outside of the fuel cell, and storing water in the reservoir tank while the fuel cell is shut down. However, since the water in the reservoir tank also freezes, it is necessary to melt the ice in the reservoir tank when re-starting. This lengthens the time required for startup, and increases the fuel consumption due to the utilization of a heater.

Once a fuel cell is being operated, it can run smoothly at an optimum temperature and efficiency. At startup, however, the cell requires a certain temperature, which is typically above the freezing point of the water contained therein to run efficiently. Hence, there is a continuing need for the efficient operation of fuel cells have water channels.

### SUMMARY OF THE INVENTION

According to a first aspect of the present invention, a fuel cell is comprised of an electrode structure including a cathode, an anode and an electrolyte put between the cathode and the anode; a fuel gas passage configured to conduct fuel to the anode; an air passage configured to conduct air to the cathode; a separator configured to supply the fuel to the fuel gas passage; and a water channel configured to allow flow of water and permit the water to pass into the separator, the water channel including a hollow structure having an inner surface and polymers respectively having polymer chains, one end of the polymer chains being connected to the inner surface and capable of forming an entanglement bindable to water molecules.

According to a second aspect of the present invention, a fuel cell is comprised of an electrode structure including a cathode, an anode and an electrolyte put between the cathode and the anode; a fuel gas passage configured to conduct fuel to the anode; an air passage configured to conduct air to the cathode; a separator configured to supply the fuel to the fuel gas passage; water channel configured to allow flow of water and permit the water to pass into the separator, the water channel including a hollow structure having an inner surface and polymers respectively having polymer chains, one end of the polymer chains being connected to the inner surface and capable of forming an entanglement bindable to water molecules; and means for discharging the water in the water channel to outside of the fuel cell when the fuel cell is shut down.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIGS. 1A, 1B and 1C illustrate representative idealized polymer chain structure in a water channel of a fuel cell in accordance with one embodiment of the present invention, in which FIG. 1A illustrates a state of the polymer chain forming an entanglement, FIG. 1B illustrates another state of the polymer chain in flow of water driven by the fuel cell, and FIG. 1C illustrates still another state of the polymer chain forming a contract form at relatively high temperatures;

FIG. 2 shows a fuel cell in accordance with one aspect of the present invention;

FIG. 3 illustrates a fuel cell in accordance with another embodiment of the present invention;

FIG. 4 is a flow diagram showing the process flow of a coolant system upon starting up a fuel cell system in accordance with an embodiment of the present invention;

FIG. 5 illustrates a flow diagram showing the process flow of a coolant system upon shutting down a fuel cell system in accordance with an embodiment of the present invention;

FIG. 6 illustrates a graph showing the history of a fuel cell stack's operating temperature in accordance with one aspect of the present invention.

### DETAILED DESCRIPTION OF THE EXEMPLARY EMBODIMENTS

Exemplary embodiments of the present invention will be described hereinafter with reference to the appended drawings.

The exemplary embodiments of the present invention are directed to a polymer fuel cell and its operation which comprises at least one water channel to feed or remove water from the fuel cell. Throughout the specification and claims, the term “water channel” is defined as what passes, transmits or conveys water and is at least in part comprised of a hollow structure which isolates the interior from the exterior, like as a tube or a pipe. In accordance with the embodiment of the present invention, the water channel has a polymeric material contained therein to reduce or minimize the potential freezing of any water in the channel. The polymer fuel cell further comprises an electrolyte membrane sandwiched between an anode electrode and a cathode electrode. The fuel cell can have a plurality of such membrane cells to form a fuel cell stack. The fuel cell stack can also have a plurality of water channels each having a polymeric material contained therein to minimize potential freezing of water.

The water channels are typically associated with the anode side electrode and provide water vapor to the cell and transport by products and other components from the cell. These channels can contain pure water and/or other components.

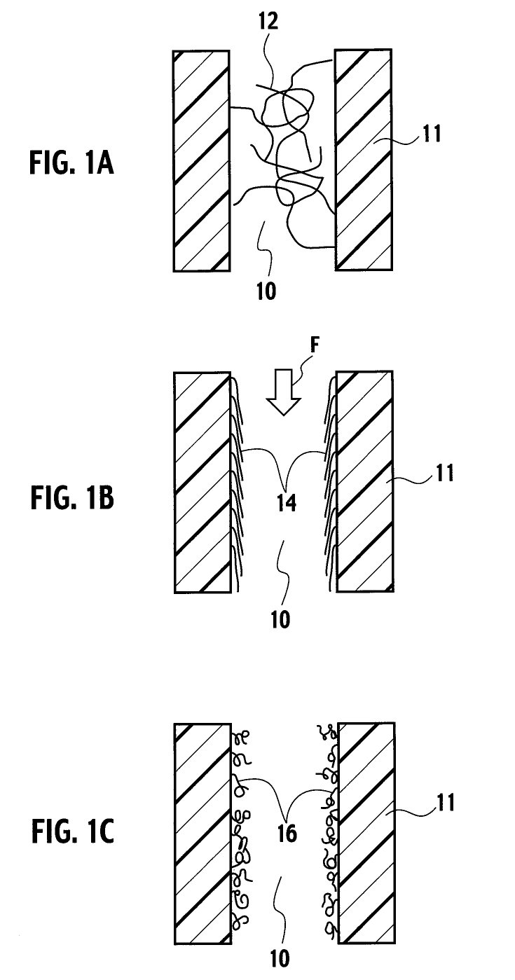

In an embodiment of the present invention, the structure of the water channel having the polymeric material is such that one end of the polymer chain is connected to the inner surface of the hollow structure of the water channel 10, as shown in FIGS. 1A-1C. Such polymer chains can form an entanglement 12 when the flow of water ceases. Within the polymer entanglements, there are water molecules that undergo binding (bound water) due to the interaction with the polymer chains. Water classified as “bound water” does not readily freeze, at or below 0° C., due to polymer-water interactions. In addition, due to the action of polymers (as well as other components) in lowering the freezing point, water contained within the polymer entanglement does not readily freeze, even at or below 0° C. Consequently, even when a fuel cell is used in an environment below 0° C., it is not necessary to discharge the water outside of the fuel cell before hand to prevent freezing, or to use a reservoir tank to discharge the water. Advantageously, when the fuel cell is re-started, it can begin to operate immediately, without re-supplying water to the channel after the cell is stopped.

As being understood from the above description, the polymer chains can go into either of two distinct states. In one of the states typically realized when the fuel cell is in operation, the polymer chains stream in the water flow F passing through the water channel 10 as shown in FIG. 1B. The polymer chains form a stretched form 14 and occupy a relatively small volume in the water channel 10. In another state typically realized in the absence of the water flow as operation of the fuel cell is stopped, the polymer chains form the entanglement 12 as shown in FIG. 1A. In this state, the polymer chains occupy a greater volume in the water channel 10 as compared with the above state as the entanglement 11 embraces a certain amount of water molecules.

Temperature change may also cause transition between these states and will be described later in more detail.

Connecting or attaching polymer chains to the inner surface of the water channel can be carried out by the general method of surface treating the contemplated surface to which the polymeric material is to be attached followed by polymerization of monomers or attachment of already formed materials. For instance, polymer chains are connected to the inner surface of the water channel by applying a plasma treatment to the inner surface of the channel and connecting the polymer chain at the active site, or by forming a polymer membrane layer on the inner surface of the channel beforehand and causing a portion of the membrane layer to react with the polymer chain.

Advantageously, the structure of the fuel cell is such that the flow of water in the water channel is ceased when the fuel cell is shut down. The polymeric material in the interior of the channel can then spread out and occupy more of the channel. When the cell is operated, however, the polymeric material occupies less channel volume. This can occur simply due to the natural tendency of the polymeric material (when some part is attached to the surface of the channel) to self associate (i.e., form entanglements) when there is no flowing water versus orienting along the flow direction when the cell is in operation, thereby ensuring the necessary flow rate of water for the operation of fuel cell. By using polymeric materials having weak entanglements among polymer chains, it is possible to form and break up the entanglements in accordance with the flow of water in the channel.

For example, polymeric materials having hydrophilic chains will spread out in water at reduced temperatures. While the fuel cell is in operation, i.e., at elevated temperatures, the polymer chains do not obstruct the flow of water, because the chains spread out in the direction in which the water flows.

In an embodiment of the present invention, the polymeric material attached to the inner surface of the water channel comprises an alkyl base. The polymer can have a principal chain which is a continuous structure having an alkyl base or it can be a copolymer whose principal chain structure is an alkyl base. Although an alkyl based polymer is preferred in this embodiment of the present invention, the polymeric material is not limited thereto. It is preferred that the polymer have enough flexibility so that entanglements can easily form in the water channel and can be easily disentangled by the flow of water in the channel.

Thermo-responsive polymers are also contemplated in the present invention. Thermo-responsive polymers can undergo volume phase transition in accordance with the temperature of the water that contain such polymers. For example, if the temperature of the water becomes high, as when the fuel cell is in operation, the polymer entanglements contract as they undergo a volume phase transition, thereby permitting the flow of water. In addition, when the temperature of the water falls, such as after the fuel cell is shut down, the polymer spreads out in the water, and the chains tend to form a weakly connected network. Since this network retains water within itself, the water does not readily freeze, even below its normal freezing point.

Any thermo-responsive polymer can be used in the present invention. Such polymer chains can form an entanglement 12 when the environmental temperature is low. Thermo-responsive polymers that contracts in water at temperatures of about 40° C. or higher, and expands in water at temperatures of about 20° C. or lower are preferred. These polymers do not block the flow of water when applied in a polymeric solid electrolyte fuel cell, within the preferred working temperature ranges of the fuel cell. In an embodiment of the present invention, the polymer chain comprises N-isopropyl acrylamide, or an N-isopropyl acrylamide co-polymer. These materials do not block the flow of water when applied in a polymeric solid electrolyte fuel cell, within the working temperature range of the fuel cell.

When the fuel cell is in operation, the temperature of the water channel comes close to the operation temperature of the fuel cell, which is around 70° C. or such. Then the polymer chains contract to form a contracted form 16 and occupy a relatively small volume in the water channel 10 to allow water flow as shown in FIG. 1C. In contrast, before the fuel cell comes into operation or after the fuel cell stops, the temperature comes close to the ambient temperature, which is about 20° C. or lower. Then the polymer chains form the entanglement 12 to embrace a certain amount of water molecules as shown in FIG. 1A. More specifically, the thermo-responsive polymers connected to the inner surface of the water channel also embodies the aforementioned transition between two states, which depends on whether the fuel cell is in operation or stopped.

Although the use of a polymeric material in the water channel can reduce the potential of water freezing therein, which thereby reduces the need to discharge water from the channel, the present invention also contemplates the use of an external reservoir and connections thereto for the discharge of water from channels. Since the fuel cell has a means of discharging the water in the water channel to outside of the fuel cell when the fuel cell is shut down, it can further prevent the water from freezing in the cell. This structure is suitable, for example, when the sectional area of the water channel is so large that the polymer chain entanglement cannot retain all of the water, but is not limited thereto.

Discharging excess water from the cell can be carried out by means of gravity or by employing a pump or by any other equivalent means. Since it is preferable to leave enough water in the fuel cell for re-start, the amount of water discharged out may be measured and then properly controlled. Discharge of water may be continued until the amount of water left in the fuel cell decreases down to a limit of retention by the polymer entanglement. In addition, if a pump is used to discharge water to the outside, pumping may be preferably so controlled as to leave an amount of water equal to or below a maximum limit of retention by the polymer entanglement. Such proper control of discharging water advantageously reduces the energy consumption of the system.

Since the fuel cell system has a means of measuring at least one of either the flow rate of water flowing through the water channel of the fuel cell system or the pressure of the water, and since it has a means of control either the flow rate or the pressure of the water, the polymer chains connected to the surface of the water channel in the fuel cell are protected from being removed. The flow rate and pressure can be a predetermined level or range.

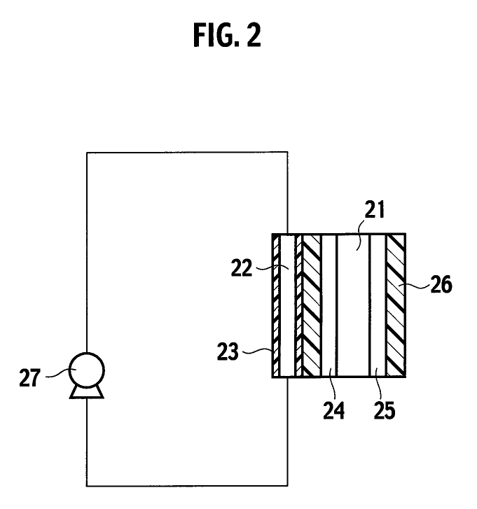

In another embodiment of the present invention, FIG. 2 illustrates an example of a fuel cell structure. The fuel cell is comprised of fuel gas passage 24 and air passage 25, one of which is adhered on one side of membrane electrode structure 21 and another of which is adhered on another side. Electrode structure 21 can comprise a polymer electrode membrane sandwiched between an anode electrode and a cathode electrode (not shown for illustrative convenience). Water channel 22 is provided so as to enclose porous separator 26, which partitions both sides thereof into fuel gas passage 24 and air passage 25. Water in water channel 22 is circulated by pump 27. Water flowing in water channel 22 passes through porous separator 26, and humidifies the fuel gas passing through fuel gas passage 24 and the air passing through air passage 25. As an example of a polymeric material contained within a water channel, one end of polymethyl methacrylate (PMMA) is connected to the surface of water channel 22, and forms PMMA molecular layer 23. In the PMMA molecular layer 23, PMMA molecules are connected perpendicular to water channel 22. PMMA molecular layer 23 can be formed using the general method of surface treatment for attaching polymers. For example, plasma treatment can be performed on separator 26, and subsequently methyl methacrylate monomer can be polymerized to attach PMMA chains on water channel 22 only, so that PMMA molecular layer 23 is formed. When the fuel cell is shut down, pump 27 stops, so that water does not circulate. In this example, the PMMA molecules of the PMMA molecular layer spread out in water channel 22, and form entanglement with other PMMA molecules.

When the atmospheric temperature surrounding a fuel cell structured as shown in FIG. 2 was lowered to −10° C., and the system was left for 8 hours, and dried hydrogen gas and air were then caused to flow, the fuel cell started to generate electricity again. At the same time, circulation of water was started by operating pump 27, and since the water had not frozen, it was immediately able to circulate. Subsequently, the fuel cell operated normally at about 70° C.

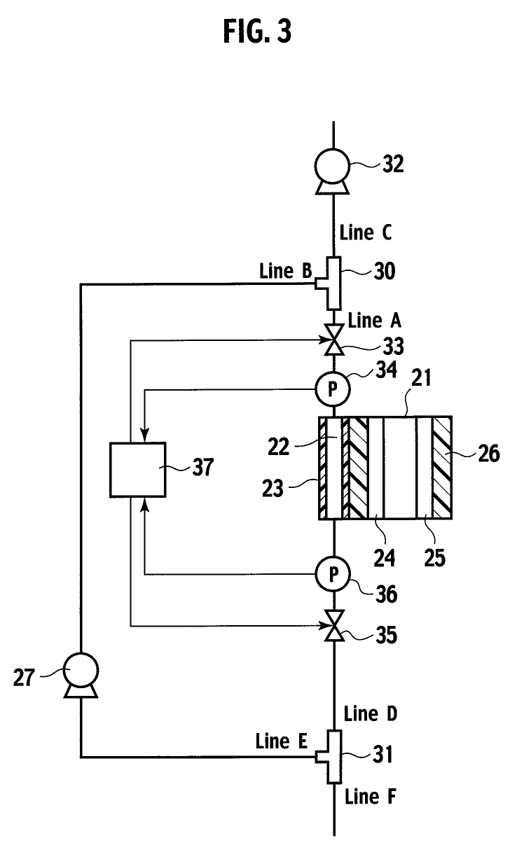

In another embodiment of the present invention, FIG. 3 illustrates an example of a fuel cell structure. The structure shown in FIG. 3 is similar to FIG. 2 except that FIG. 3 illustrates a means for draining a water channel outside of the cell and outside of the system. As shown in FIG. 3, fuel gas passage 24 and air passage 25 are provided on either side of membrane electrode 21. Water channel 22 is provided so as to enclose porous separator 26, which partitions both sides thereof into fuel gas passage 24 and air passage 25. Water channel includes polymer layer 23 which is attached to the inner surface of the channel. Blower 27 is connected to water channel 22 through lines A, B, E, and D. Water can be made to circulate through the cell by actuating blower 27 and three-way valves 30 and 31. Water can be drained from the cell by actuating three-way valves 30 and 31 and blower 32.

Also included in the circulating water loop are pressure gauges 34 and 36 which feed a signal to pressure controller 37 which in turn controls control valves 33 and 35 so as to control pressure. As is known in the art, a computer or microprocessor can be used to control three-way valves 30 and 31 as well as pressure controller 37 and control valves 33 and 35. The apparatus shown in FIG. 3 permits recycling of water while the cell is functioning during a normal electricity generation mode. When the cell is shut down, this apparatus can be operated such that water is drained from the cell as needed to remove excess water in the water channel that is not bound by polymer layer 23.

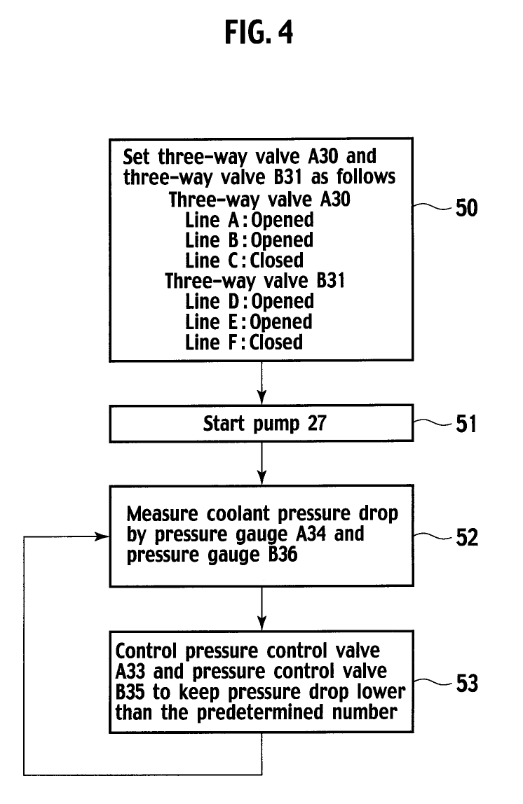

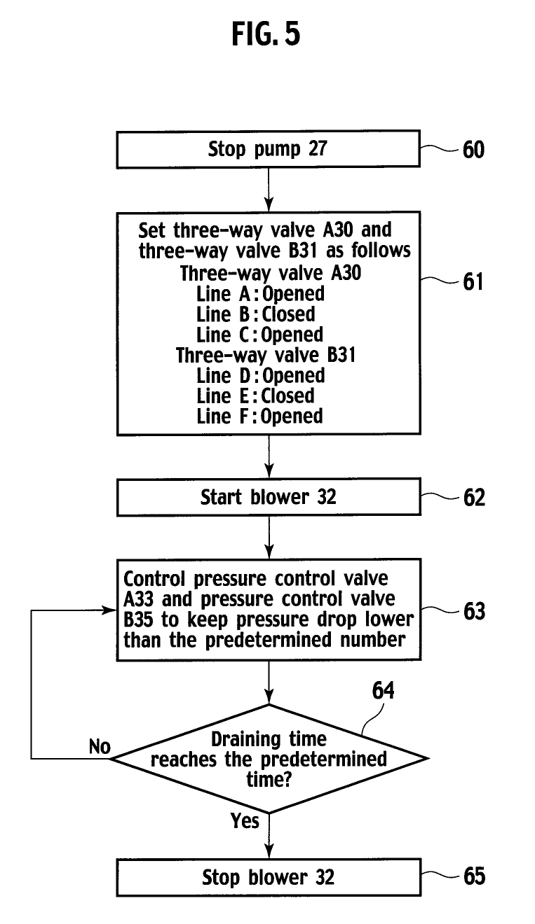

The operation of a fuel cell with a water channel will be provided with reference to the flow diagrams of FIGS. 4 and 5 and with reference to the apparatus shown in FIG. 3. As is understood by those skill in the art, this operation can be computer controlled for optimum results in operation.

As seen in FIG. 4, start-up operation begins at 50. During startup, three-way valve 30, as shown in FIG. 3, allows water to flow through lines A and B. Line C is closed. Three-way valve 31, shown in FIG. 3, allows water to flow through lines D and E and closes line F. At step 51, pump 27 is turned on which permits water to circulate through the cell. At step 52, the pressure drop in the circulating water is measured by pressure gauge 34 and 36. The pressure measurements are inputted to controller 37. At step 53, pressure control valves 33 and 35, are operated by controller 37 to maintain a predetermined pressure in the circulating flow of water circulating through the cell.

FIG. 5 is a flow diagram illustrating the operations of the fuel cell of FIG. 3 during a shut down operation. As seen in FIG. 5, shut down begins at step 60 with the stopping of pump 27. At step 61, three-way valve 30 is set so that line A and line C are opened and line B is closed. Three-way valve 31 is set so that lines D and F are open and line E is closed. At step 62, blower 32 is operated. At step 63, the pressure in the water channel is monitored by pressure gauges 34 and 36 which sends a signal to controller 37 which in turn operates control valves 33 and 35 to ensure a predetermined pressure range. At step 64, a decision is made whether enough time has elapsed. The elapsed time can be preset and can depend on such factors as the volume of water in the water channel, the amount of polymer contained in the water channel, the amount of water necessary to operate the cell at start up, the outside temperature, etc. all of which can be empirically predetermined. If the drainage time has not elapsed, the system returns to step 64. If the time has elapsed, the system goes to step 65 which halts blower 32.

Reference is now made to the following examples for illustrative purposes.

### EXAMPLE 1

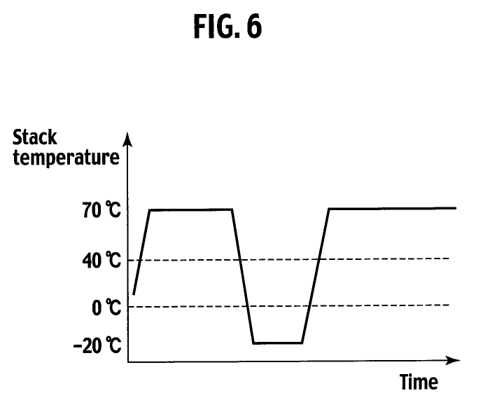

In this example, a fuel cell stack having cells with a basic structure shown in FIG. 2 was used. The cells differ in that one end of N-isopropyl acrylamide is connected to the surface of the water channel rather than PMMA. The N-isopropyl acrylamide was attached to the channel wall by plasma polymerization. This fuel cell stack was operated by the procedure shown in FIG. 6. After startup at room temperature, the cell is operated at about 70° C., and is subsequently shut down. After shutdown, the atmospheric temperature surrounding the fuel cell is lowered to −20° C. The N-isopropyl acrylamide undergoes volume phase transition at about 40° C., and expands in the water channel. After maintaining the cell for 8 hours at −20° C., dried hydrogen gas and air at 40° C. were caused to flow, which caused the cell to start generating electricity again. At the stage where the fuel cell temperature reaches 40° C., water starts to circulate. Due to the rise in fuel cell temperature, the N-isopropyl acrylamide contracts in the water channel. Due to the contraction of the N-isopropyl acrylamide, the flow rate of water in the water channel is established at the rate necessary for normal operation. Subsequently, the fuel cell stack temperature reaches 70° C., and normal operation comes into effect, without a noticeable voltage drop.

### EXAMPLE 2

In this example, a fuel cell having the basic cell structure as shown in FIG. 3 was used. In addition to the implementation of example 1, three-way valve 30, three-way valve 31 and blower 32 are set in the coolant loop. Pressure gauge 34 and pressure gauge 36 are set to control pressure control valve 33 and pressure control valve 35 through pressure controller 37. During operating the fuel cell system, three-way vale 30 and three-way valve 31 are set as follows to make a loop.

| Three-way valve 30 | Three-way valve 31 |
|---|---|
| Line A: Opened | Line D: Opened |
| Line B: Opened | Line E: Opened |
| Line C: Closed | Line F: Closed |

First, three-way vale 30 and three-way valve 31 are set as follows to drain water from the fuel cell stack when the fuel cell system is shut down.

| Three-way valve 30 | Three-way valve 31 |
|---|---|
| Line A: Opened | Line D: Opened |
| Line B: Closed | Line E: Closed |
| Line C: Closed | Line F: Opened |

Secondly, blower 32 starts to drain water from fuel cell stack. Blower 32 stops after a predetermined time period.

During operating a fuel cell system and draining water from a fuel cell stack, pressure controller 37 controls pressure control valve 33 and pressure control valve 35 to keep the pressure drop of the coolant channel inside the fuel cell stack under a predetermined pressure.

Only the exemplary embodiments of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific procedures and arrangements described herein. Such equivalents are considered to be within the scope of this invention, and are covered by the following claims.

What is claimed is:

1. A fuel cell comprising:
an electrode structure including a cathode, an anode and an electrolyte put between the cathode and the anode;
a fuel gas passage configured to conduct fuel to the anode;
an air passage configured to conduct air to the cathode;
a separator configured to supply the fuel to the fuel gas passage; and
a water channel configured to allow flow of water and permit the water to pass into the separator, the water channel including a hollow structure having an inner surface and polymers respectively having polymer chains, one end of each of the polymer chains being connected to the inner surface and capable of forming an entanglement bindable to water molecules.

2. The fuel cell of claim 1, wherein the polymer chains are so designed as to form the entanglement in response to stop of the fuel cell and break up the entanglement in response to operation of the fuel cell.

3. The fuel cell of claim 2, wherein the polymer chains occupy a greater volume when the entanglement is formed than a volume occupied by the polymer chains in the absence of the entanglement.

4. The fuel cell of claim 1, wherein the polymers are so designed as to break up the entanglement of the polymer chain by the flow of the water.

5. The fuel cell of claims 1 or 4, wherein the polymer chain is hydrophilic.

6. The fuel cell of claim 4, wherein the polymer chain includes a continuous alkyl group.

7. The fuel cell of claim 1, wherein the polymers are thermo-responsive and capable of volume phase transition in accordance with a temperature of the water.

8. The fuel cell of claim 7, wherein the thermo-responsive polymers contract in water at temperatures of 40° C. or higher, and expand in water at temperatures of 20° C. or lower.

9. The fuel cell of claim 8, wherein the polymer chain includes N-isopropyl acrylamide.

10. A fuel cell comprising:
an electrode structure including a cathode, an anode and an electrolyte put between the cathode and the anode;
a fuel gas passage configured to conduct fuel to the anode;
an air passage configured to conduct air to the cathode;
a separator configured to supply the fuel to the fuel gas passage;
a water channel configured to allow flow of water and permit the water to pass into the separator, the water channel including a hollow structure having an inner surface and polymers respectively having polymer chains, one end of the polymer chains being connected to the inner surface and capable of forming an entanglement bindable to water molecules; and
means for discharging the water in the water channel to outside of the fuel cell when the fuel cell is shut down.

11. The fuel cell of claim 10, further comprising:
means for measuring a parameter selected from the group of the flow rate of water flowing through the water channel of the fuel cell system and the pressure of the water; and
means for controlling the parameter so as not to exceed a level.
